(19) United States
(12) Patent Application Publication
(10) Pub. No.: US 2026/0140138 A1
(43) Pub. Date: May 21, 2026

(54) Cryo-Compatible Sample Holder for In-Situ Microscopy and Sample Characterization

(71) Applicant: Massachusetts Institute of Technology, Cambridge, MA (US)

(72) Inventors: Dirk Robert ENGLUND, Brookline, MA (US); Jawaher ALMUTLAQ, Cambridge, MA (US); Mohamed ElKabbash, Cambridge, MA (US)

(21) Appl. No.: 18/940,672

(22) Filed: Nov. 7, 2024

Related U.S. Application Data
(60) Provisional application No. 63/596,958, filed on Nov. 7, 2023.

(51) Int. Cl. G01Q 30/20; G01Q 60/10; G01Q 60/24

(52) U.S. Cl. CPC G01Q 30/20; G01Q 60/10; G01Q 60/24

(57) ABSTRACT

A sample holder for advanced in-situ microscopy is described. The sample holder includes integrated devices to apply external fields and other stimuli to samples being inspected. The integrated devices can emulate operating environments for the samples. The sample holder and advanced microscopy can be used to study quantum characteristics and properties of samples.

### CROSS-REFERENCE TO RELATED APPLICATIONS

This application claims the priority benefit, under 35 U.S.C. 119(e), of U.S. Application No. 63/596,958, filed Nov. 7, 2023, titled “Cryo-Compatible Universal Substrates for In-Situ Quantum Microscopy Imaging and Characterization,” which application is incorporated herein by reference in its entirety.

### GOVERNMENT SUPPORT STATEMENT

This invention was made with government support under W911NF1810432 awarded by the Army Research Office. The government has certain rights in this invention.

### BACKGROUND

Advanced microscopy tools, such as atomic force microscopes, high-resolution optical microscopes, electron-beam microscopes, ion-beam microscopes, and quantum microscopes can provide valuable insights into the properties and characteristics of various materials and devices. Such microscopes have significantly contributed to groundbreaking discoveries in the fields of microelectronics, nanostructures, quantum-electronic and quantum-optical devices.

### SUMMARY

The present disclosure relates to a sample holder that can be used to image and characterize samples in-situ with advanced microscopy tools. These microscopy tools can resolve features to the micrometer scale and below. The sample holder can be used to support samples in a vacuum environment, including a cryogenic environment, and to apply electric fields, magnetic fields, electromagnetic fields, and other external stimuli to the samples while the samples are being inspected with the advanced microscopy tool. The sample holder can be fabricated using conventional complementary metal-oxide-semiconductor (CMOS) processes and can be mounted on a platform, such as a printed circuit board (PCB), to facilitate electrical connections to devices fabricated on the sample holder such as integrated electrodes, heaters, inductors, sensors, and optical devices.

Some implementations relate to a sample holder for micrometer-scale microscopy. The sample holder comprises: a bulk substrate; and a process stack disposed on the bulk substrate. The process stack comprises apertures devoid of material passing through the process stack to allow electrons or ions to pass through the apertures when using the sample holder for the micrometer-scale microscopy, and at least one patterned feature forming an etch mask for etching the apertures through the process stack.

Some implementations relate to a method of inspecting a sample with the sample holder described above. The method can comprise acts of: receiving the sample on a device formed on or in the process stack over the at least one patterned feature; and affecting a characteristic of the sample with an electric field, a magnetic field, or an electromagnetic field generated by the device.

All combinations of the foregoing concepts and additional concepts discussed in greater detail below (provided such concepts are not mutually inconsistent) are part of the inventive subject matter disclosed herein. In particular, all combinations of subject matter appearing in this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally and/or structurally similar elements).

FIG. 1 depicts a sample holder positioned in an inspection chamber of an advanced microscopy tool.

FIG. 2 depicts further details of the sample holder of FIG. 1.

FIG. 3A depicts an example of a heater that can be integrated on the sample holder of FIG. 1.

FIG. 3B depicts further details of the heater of FIG. 3A.

FIG. 3C depicts an intermediate structure associated with the heater of FIG. 3A.

FIG. 4A shows an example of electrodes that can be integrated on the sample holder of FIG. 1.

FIG. 4B shows further details of the electrodes of FIG. 4A.

FIG. 5A shows another example of electrodes that can be integrated on the sample holder of FIG. 1.

FIG. 5B shows another example of electrodes that can be integrated on the sample holder of FIG. 1.

FIG. 6A depicts another example of electrodes that can be integrated on the sample holder of FIG. 1.

FIG. 6B plots the simulated electric field profile for the electrodes of FIG. 6A when biased.

FIG. 7 shows an example of an inductor that can be integrated on the sample holder of FIG. 1.

FIG. 8 depicts an example of a piezoelectric transducer that can be integrated on the sample holder of FIG. 1.

FIG. 9 shows samples disposed on the surface of electrodes like those of FIG. 5B.

### DETAILED DESCRIPTION

The inventors have recognized and appreciated that advanced microscopy methods are limited in their ability to inspect a sample in environments in which the sample might operate. Inspected samples can comprise material that may be used to make nano-scale electronic devices, magnetic devices, optical devices, or some combination thereof. As an example of conventional advanced microscopy, an inactive sample is placed inside a vacuum chamber in an advanced microscope for inspection by a focused ion beam or focused electron beam. The sample is not subjected to any controlled, externally-applied electric fields or magnetic fields that might emulate environments in which the sample might operate.

Having the ability to inspect, with advanced microscopy systems, materials and micro-scale and nano-scale devices in controlled environments that can emulate operating environments for the materials and devices can further advance discoveries and innovation in the fields of micro-scale and nano-scale structures.

### 1. Sample Holder

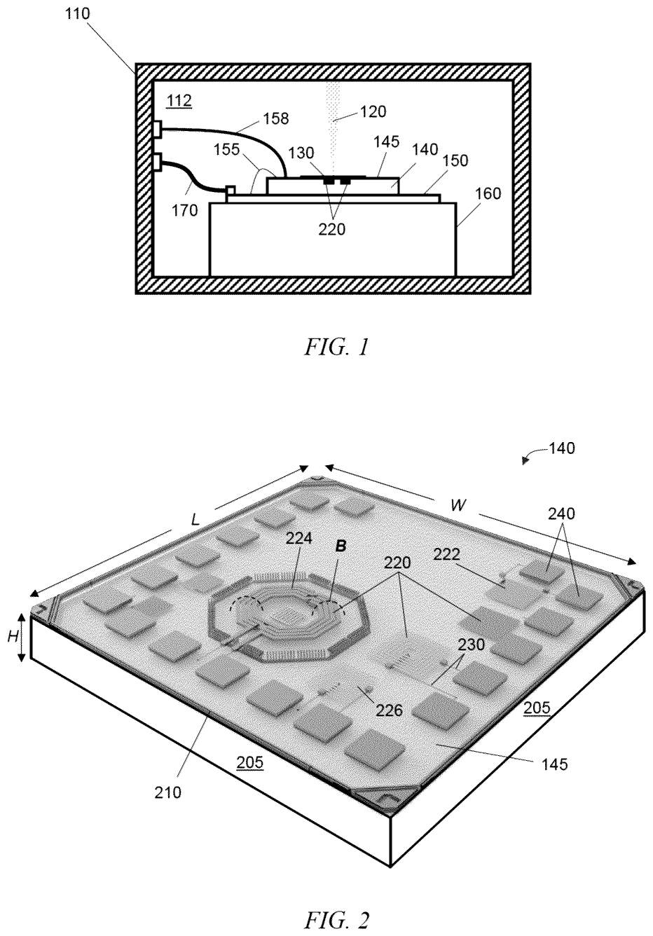

FIG. 1 depicts a sample holder 140 positioned in an inspection chamber 112 of an advanced microscopy tool. The inspection chamber 112 can be enclosed by an enclosure 110 that can support a vacuum environment (e.g., for electron-beam, ion-beam, or quantum microscopy) or provide a darkened and/or vibration-isolated, non-vacuum environment (e.g., for optical microscopy or atomic force microscopy). As one example, the inspection chamber 112 is part of a scanning tunneling microscope (STM) and a focused electron beam 120 is incident on a sample 130, which is supported on a sample-supporting surface 145 of the sample holder 140. However, the sample holder 140 can be used in other advanced microscopy systems mentioned above.

In some implementations, the sample holder 140 (which may be referred to as a quantum system on chip—QSoC) comprises a semiconductor chip. The sample holder 140 can include one or more devices 220 formed on the sample holder at or near the sample-supporting surface 145 of the sample holder 140, as described further below. Such devices can be used to generate electric fields, magnetic fields, electromagnetic fields, and/or heat at the location of the sample 130 (e.g., to interact with or affect the sample). Electromagnetic fields are time-varying electric and magnetic fields that may oscillate at radio frequencies (RF). Electric fields and magnetic fields are considered to be static or slowly varying fields, such that the generated fields are essentially (99% or more) either electric fields or magnetic fields. The generated fields can extend from, and out of the plane of, the sample-supporting surface 145 and impinge on a sample 130 mounted on the sample-supporting surface. Such fields or heat can emulate an environment in which the sample might operate when material like that of the sample is implemented in a device for an application outside the inspection chamber 112 (e.g., implemented in an integrated electrical or optical device on a commercial chip).

In some implementations, one or more sample holders 140 can be mounted on a platform 150, such as a printed circuit board (PCB). The platform 150 can facilitate handling of the sample holder(s) 140 when mounting samples 130 and transporting the samples in and out of the inspection chamber 112. Electrical connections between contact pads 240 and devices 220 on the sample holder 140 and conductive traces on the platform 150 can be made with bond wires 155 or other structure (e.g., solder bumps and through-substrate vias, circuit probes, conductive clips, etc.). In some implementations, electrical connections between contact pads 240 and devices 220 on the sample holder 140 and structure(s) within the inspection chamber 112 can be made with the bond wires 155 or other structure(s) (e.g., circuit probes, conductive clips, etc.). Electrical connections to an external device outside the inspection chamber 112 can be made with wired links 170 or wireless links (e.g., with a wireless transceiver mounted on the platform 150 or formed on the sample holder 140). The sample holder 140 can be mounted on a positioning stage 160, when placed in the inspection chamber 112, directly (when a platform 150 is not used) or indirectly (mounted on the platform 150 which is mounted on the positioning stage 160).

In some cases, optical connection(s) can be made to the sample holder 140. For example, an optical fiber 158 can couple to an optical device and/or optical waveguide disposed on the sample holder. Optical coupling to the sample holder 140 can be done by butt coupling the optical fiber 158 to a waveguide formed on the sample holder, or by using a grating coupler or other optical coupler formed on the sample holder to couple light from the optical fiber 158 into an integrated waveguide. Optical radiation can be delivered to specific regions of a sample 130 (e.g., with integrated waveguides formed on or in the sample holder) or to the entire sample. Optical excitation of the sample 130, or regions of the sample, can be performed at one or more wavelengths. In some implementations, an optical excitation source can be integrated directly on or in the sample holder 140. Simultaneous optical excitation of a sample and electron-based measurements can be carried out (e.g., using the focused electron beam 120 or ion beam for imaging while optically exciting the sample). Such excitation and inspection can be useful for materials that exhibit phenomena like quantum confinement, photonic crystal effects, or optical modulation.

FIG. 2 depicts further details of the sample holder 140, according to one example implementation, though various configurations of the sample holder are possible. For the illustrated example, the sample holder 140 comprises a bulk substrate 205, which can be formed from semiconductor material. Examples of semiconductor material that can be used for the bulk substrate 205 include silicon (Si), silicon carbide (SiC), silicon nitride (SiN), germanium (Ge), silicon germanium (SiGe), gallium arsenide (GaAs), gallium nitride (GaN), indium phosphide (InP), and other semiconductor materials that can be used to form integrated electronic devices and/or integrated optical devices on the sample holder 140. In some implementations, other materials, such as ceramics and glasses, can be used to form the bulk substrate 205.

The sample holder 140 can be small in size or large (since it can be manufactured from a semiconductor wafer). The sample holder can readily fit within inspection chambers of electron microscopes and can be mounted on a platform 150 (such as a PCB) to facilitate handling of the sample holder and electrical connections with devices formed on the sample holder 140. The height H of the sample holder 140 can be from approximately or exactly 0.05 mm to approximately or exactly 2 mm. Either of the width W and length L of the sample holder 140 can be from approximately or exactly 0.5 mm to approximately or exactly 10 mm, though larger sizes are possible. When mounted on the platform 150, the size of the platform can be larger in terms of width and length than the sample holder 140 (e.g., either of the width and length of the sample holder 140 can be from approximately or exactly 1 mm to approximately or exactly 20 mm, though larger sizes are possible).

The sample holder 140 further comprises a process stack 210 on a top side of the sample holder where samples 130 will be mounted. The process stack 210 can include semiconductor material (e.g., a top portion of the bulk substrate 205), one or more metal layers, and one or more insulator layers. One or more devices 220 can be formed from material in the process stack. The devices 220 can include, but are not limited to, electrodes 222 for creating static electric fields, slowly time-varying electric fields, or electromagnetic fields (such as RF fields) in the vicinity of the electrodes, inductors 224 for creating static magnetic fields, slowly time-varying magnetic fields, or electromagnetic fields in the vicinity of the inductors, heaters 226 for generating heat, integrated optical devices for emitting optical radiation, as well as detectors (such as photodetectors, thermal sensors, and magnetic sensors). The electric and magnetic fields (such as magnetic field B in the drawing) can rise up from the surface and pass through a sample disposed on the surface of the sample holder. Metal layers in the process stack 210 can be used for interconnects 230 to the devices 220 as well as other structures (such as etch masks) described further below. In some implementations, the sample holder 140 can further comprise contact pads 240 disposed on the sample holder for making electrical connections to devices 220 formed on the sample holder 140. Devices 220 and microstructures formed on the sample holder 140 (such as interconnects 230 and contact pads 240) can be formed using CMOS processes.

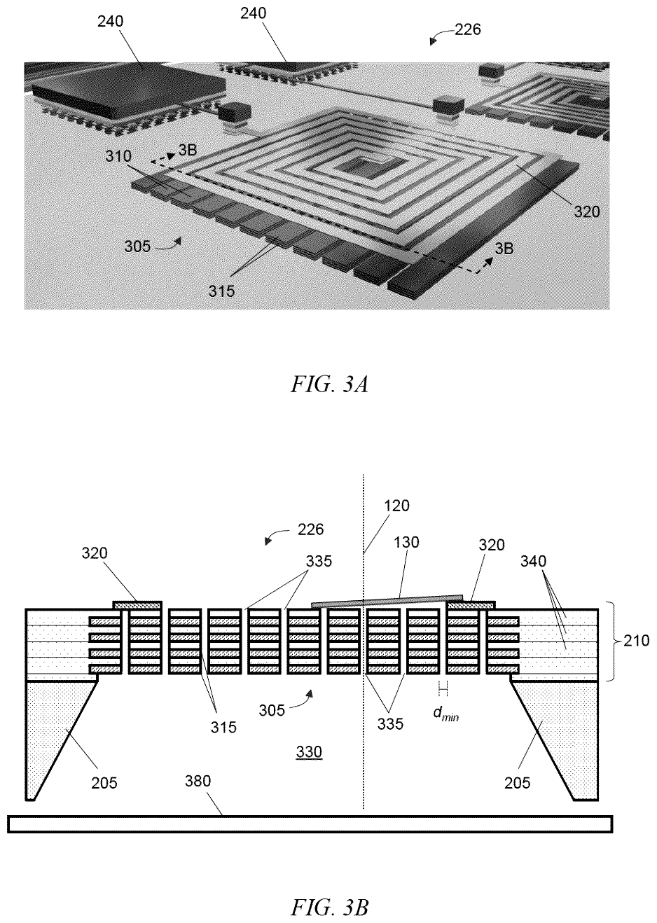

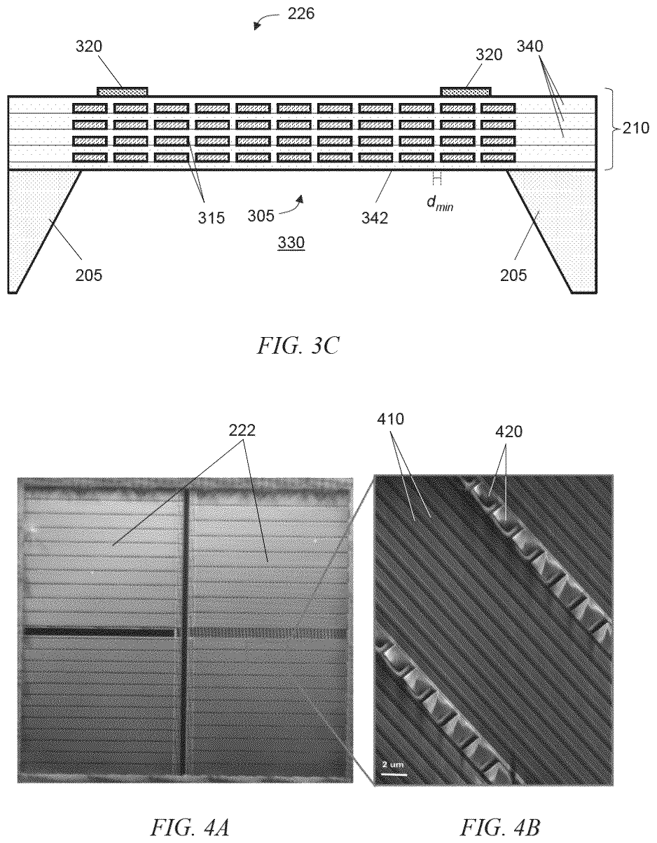

FIG. 3A depicts further details of structure around a heater 226 formed on a sample holder 140. A contact pad 240 is electrically connected to the heater 226 at one end of a spiral heating element 320. The second end of the heating element 320 connects to a second contact pad 240, a portion of which is visible in the illustration. Driving electrical current through the spiral heating element 320 produced localized heating, which can affect a sample placed on or over the heater 226 for inspections. The spiral heating element 320 can be formed from a resistive metal or alloy, such as nickel-chromium, or another resistive material. The thickness of the heating element can be from 100 nm to 2 microns. The heating element 320 can be formed in shapes other than spiral. In some cases, the heating element 320 can also be used to generate a magnetic field.

Below the heater 226 is a patterned etch mask 305 comprising a plurality of patterned features 310 (parallel bars in this example). Other patterned features can be used for the etch mask including grids and arrays of openings of any shape in at least one masking layer (such as a metal layer). For the example of FIG. 3A, the patterned features 310 are formed from four stacked metal layers 315, which can be deposited, patterned, and etched using CMOS processes to form the bars. The etch mask 305 can be used to form small apertures 335 (devoid of any material) that extend through the heater 226 and process stack 210 for transmission electron microscopy (TEM). Other materials (e.g., amorphous silicon, silicon nitride) can be used for the patterned features 310 that can serve as an etch mask for etching apertures through the heater 226, the inductor 224, and the electrodes 222. The thickness of the patterned features can be from 100 nm to 500 nm, though other thicknesses are possible.

FIG. 3B depicts further details of structures in the vicinity of the heater 226 of FIG. 3A. The illustration shows the apertures 335 that extend through the heater 226 and process stack 210. The illustration of FIG. 3B is a cross-sectional view at the location indicated by the dashed line in FIG. 3A. The bulk substrate 205 has been etched away below the heater 226 to form an empty cavity 330 in the bulk substrate 205. The empty cavity could be formed by a wet isotropic etch (e.g., using a solution that would chemically etch the bulk substrate 205) or by a dry anisotropic etch (e.g., a deep reactive-ion etch). The cavity 330 can be located on the bottom side of the sample holder 140, opposite the side having the process stack 210 and sample-supporting surface 145. The cavity provides a region devoid of material that can extend to the process stack 210. The lateral dimensions of a cavity 330 (measured in a plane parallel to the top or bottom surface of the sample holder 140) can be from approximately or exactly 1 micron by 1 micron to approximately or exactly 1 mm by 1 mm or even larger. There can be one or more cavities 330 formed in a sample holder 140.

The apertures 335 through the process stack 210 can be formed using a dry anisotropic etch (e.g., reactive ion etching) and using one or more patterned etch-resist layers 315 (e.g., patterned metal layers or other etch-resist material) in the process stack as the etch mask 305. The apertures 335 can be formed in any shape (round, square, rectangular, polygonal) and have openings (through which electrons can pass) with a minimum diameter from 5 microns to 50 nm or even smaller. Patterned at or near the top of the process stack 210 is the spiral heating element 320 of the heater 226. There can be from 1 to 9 etch-resist layer 315. The heater 226 and inductor 224 can be formed, at least in part, from one or more of the etch-resist layers.

Electrically insulating layers 340 (such as layers of an oxide or other dielectric) can separate etch-resist layers 315 of the etch mask and/or separate the integrated device (a heater 226 in this example) from the etch-resist layers 315 (e.g., to electrically isolate the device from the etch-resist layers 315. The thickness of an insulating layer 340 can be from 50 nm to 300 nm. In some implementations, an electrically insulating layer or other protective layer can at least cover the spiral heating element such that a sample placed across the heating element 320 would not short the heating element. Such a covering could be formed using a conformal plasma deposition of an insulator, such as silicon dioxide.

For TEM or STM, a sample 130 can be placed on the heater 226 (or other device 220) over the etch mask 305 and small apertures 335. A focused electron beam 120 can pass through the sample and pass through the small apertures 335 and cavity 330 for detection by a detector 380 to form a TEM or STM image of the sample 130. The apertures 335 can have a minimum lateral dimension dₘᵢₙ from approximately or exactly 100 nm to approximately or exactly 5 microns, for example, though smaller or larger sizes can be used in some implementations. In some cases, the lateral dimensions of an aperture 335 (measured in a plane parallel to the sample-supporting surface 145 of the sample holder 140) can be from approximately or exactly 5 microns by 5 microns to approximately or exactly 0.2 microns by 0.2 microns or even smaller.

FIG. 3C depicts, in cross section, the structure of the sample holder 140 for the region shown in FIG. 3B prior to etching the apertures 335 through the process stack 210. The insulating layers 340 extend across the region. To etch the apertures 335, the sample holder 140 can be inverted and placed in a reactive ion etcher, for example. Ions from the plasma in the etcher can then be incident on the bottom side (side having the bulk substrate 205) of the sample holder to etch through a first insulating layer 342. The etch can then proceed through subsequent insulating layers 340 to thereby form apertures 335 shown in FIG. 3B. The first insulating layer 342 can be the same as, or different from, other insulating layers 340 in the process stack 210.

The heater 226 of FIG. 3A and FIG. 3B is only one example of a device that can be formed on the sample holder 140 over a cavity 330 and etch mask such that small apertures 335 can be etched through the device and sample holder 140. In some implementations, an inductor 224 to produce magnetic or electromagnetic fields at the location of a sample 130 supported on the sample holder 140 and/or a device comprising electrodes 222 to produce electric fields or electromagnetic fields at the location of the sample 130 can be formed on the sample holder 140 over a cavity 330 and etch mask.

### 2. Example Devices Formed on the Sample Holder

FIG. 4A is a microscope image of electrodes 222 formed on a sample holder 140. In this example, the electrodes 222 are interdigitated electrodes comprising parallel conductive microstructure bars 410 that can be electrically connected to different electric potentials (e.g., alternating positive and negative potentials to form interdigitated electrodes). When the bars 410 are connected to electric potentials, the electrodes 222 can create electric fields that extend out of the plane of the upper surface of the sample holder 140 and can impinge on a sample disposed on or above the electrodes 222. FIG. 4B is a scanning electron microscope (SEM) image showing further detail of the structure of the electrodes 222 of FIG. 4A. The bars 410 are less than 1 micron in width and spaced apart by less than 1 micron. Other sizes and spacings are possible. The SEM image further shows patterned features 420 in a metal layer below the bars 410. The patterned features 420 can serve as an etch mask for creating small openings through the process stack 210 and electrodes 222 for TEM or STM imaging of a sample placed on or above the electrodes 222.

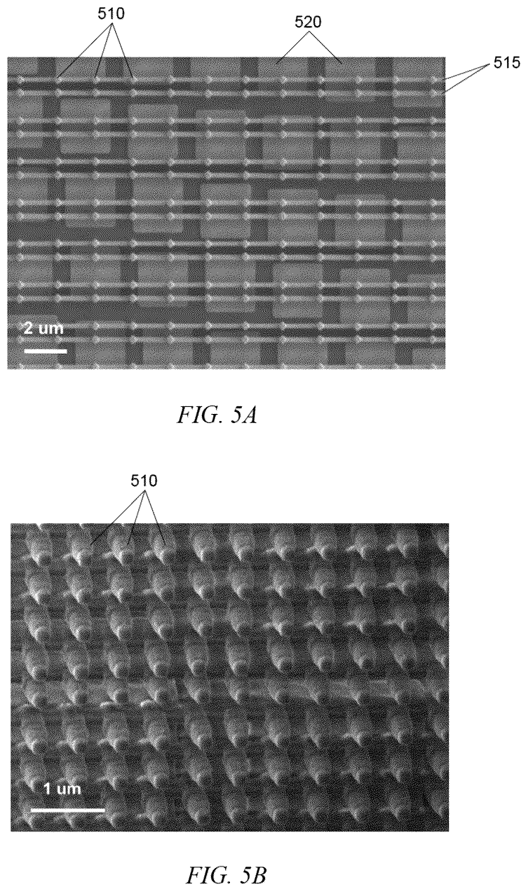

FIG. 5A and FIG. 5B are SEM images showing another implementation of electrodes 222. For this implementation, the electrodes comprise pillars 510 of conductive material electrically connected in rows by conductive traces 515. Other arrangements of the pillars 510 and electrical connections are possible. There can also be patterned features 520 in one or more metal layers below the electrodes 222 that can serve as an etch mask in some implementations. FIG. 5B shows another arrangement of the connected pillars 510 in perspective view, for which the distance between pillars is more uniform. The tips of the pillars are approximately 250 nm in diameter and the distance between pillars is approximately 600 nm, though other sizes and spacings can be implemented. A sample 130 to be inspected can be disposed on or over the pillars 510 when a sample holder 140 having pillar-type electrodes as in FIG. 5A and FIG. 5B is in use.

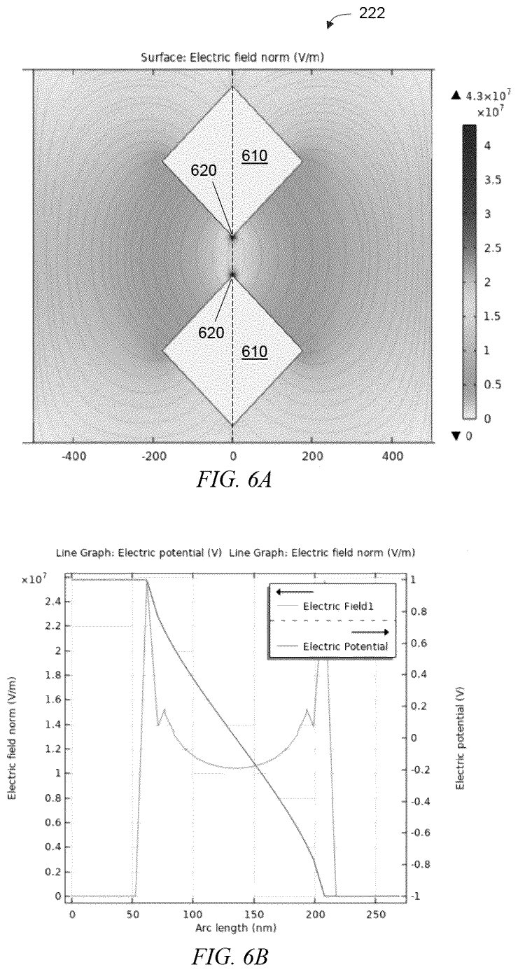

FIG. 6A depicts another implementation of electrodes 222 (forming a bowtie electrode) comprising two diamond-shaped, pointed conductors 610 patterned a distance apart on the sample holder 140. The apexes 620 of the pointed conductors 610 intensify the electric field produced by the electrodes 222 when biased. The apexes 620 can be less than 5 microns apart from each other, or even less than 1 micron apart. Plotted in FIG. 6A is the magnitude of the simulated electric field (at the plane of the pointed conductors 610). The electric field can be produced when an electric potential of 2 volts is applied across the conductors 610. FIG. 6B plots the magnitude of the generated electric field along the dashed line in FIG. 6A.

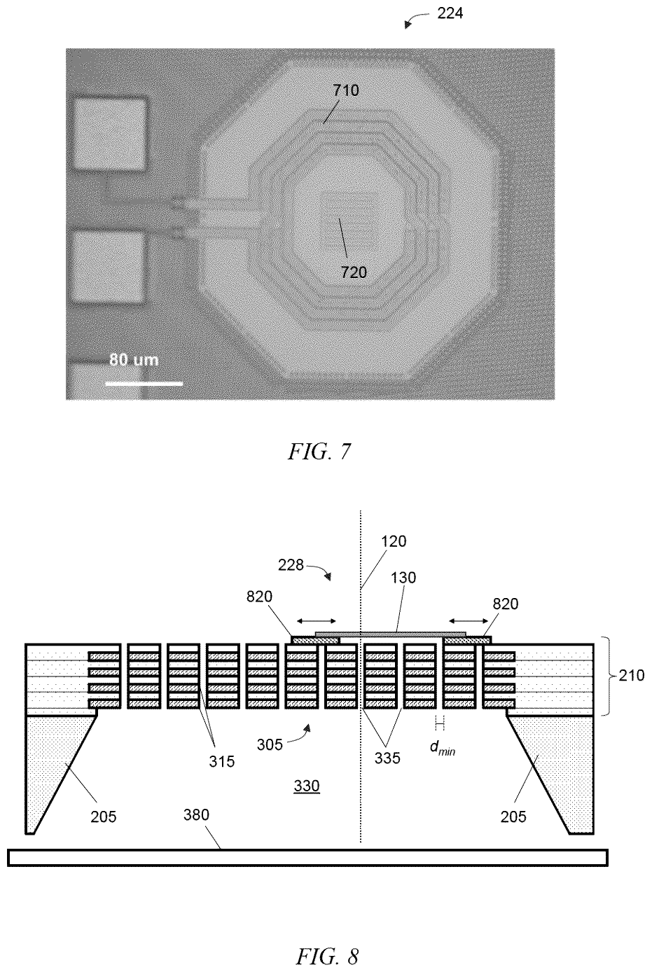

FIG. 7 is a microscope image of an inductor 224 patterned on a sample holder 140. The inductor 224 comprises a 4-turn spiral conductor 710 that has been patterned using CMOS processes. The spiral conductor measures approximately 200 microns in diameter, though smaller or larger inductors with fewer or more turns can be implemented. The inductor 224 can produce a magnetic field having a magnitude of approximately 50 mT to 200 mT at its center with the application of 2 mA to 4 mA of current flowing in the spiral conductor 710. The power supply to drive current through the inductor was operated with an output voltage from 1 volt to 2 volts. The spiral conductor 710 can be formed from a conductive metal and can have an inductance from 1 nH to 5 nH. The thickness of the spiral conductor 710 can be from 1 micron to 4 microns, though other thicknesses can be used. Other shapes can be used to form the inductor 224.

There can be at least one patterned feature 720 in one or more metal layers of the process stack 210 below the inductor 224 that can serve as an etch mask to form apertures through the process stack 210 and inductor for TEM and STM imaging, as described in connection with FIG. 3B. A sample 130 to be inspected can be disposed on or over the inductor 224 when the sample holder 140 is in use. The inductor 224 can be used to evaluate magnetic properties of materials, such as magnetic susceptibility, and/or the optical Faraday effect. To evaluate Faraday rotation, an optical beam from a laser can be focused onto the sample 130 or coupled to the sample by an optical fiber and waveguide. The optical beam can be analyzed for reflection and/or polarization rotation after reflecting from and/or passing through the sample while applying magnetic fields to the sample with the inductor 224.

FIG. 8 depicts an example of a piezoelectric transducer 228 that can be integrated on the sample holder of FIG. 1. The piezoelectric transducer 228 can comprise piezoelectric elements 820 across which the sample 130 can be placed (e.g., transfer printed). The sample 130 can be adhered to the piezoelectric elements 820 with an adhesive layer or adhesive film. In some implementations, frictional force, electrostatic bonding, covalent bonding, ionic bonding, or chemical bonding can be used to secure the sample 130 to the piezoelectric elements 820. Applying voltages to the piezoelectric elements 820 can cause them to expand and contract (indicated by double-ended arrows in the drawing), depending on the polarity of the applied voltage. Expansion of the piezoelectric elements 820 can induce compressive stress on the sample, whereas contraction of the piezoelectric elements 820 can generate tensile stress.

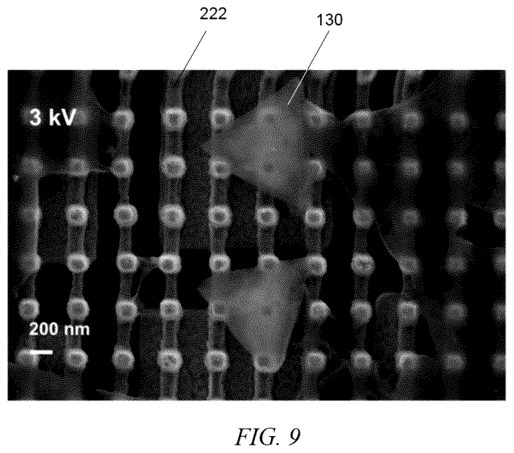

FIG. 9 is a low-voltage (3 kV) SEM image of a pillar-type electrode 222 (like that of FIG. 5B) on which is disposed several samples 130. The samples 130 rest on the tips of the pillars of the electrode 222. The samples 130 can be imaged in either one or both of two modes on the sample holder: (1) surface mode for topology (e.g., SEM imaging) and (2) tunneling mode for material structure (e.g., TEM or STM imaging). The samples 130 can be imaged while applying an external electric field to the samples.

### 3. Applications and Advantages

Because the above-described sample holder 140 can be fabricated from materials used in CMOS processing, it can be manufactured reliably in large quantities at low cost and can be used for room-temperature to cryogenic-temperature inspection of samples. Various applications are possible. The sample holder 140 can allow researchers to observe and analyze real-time changes in temperature, electric and magnetic fields, increasing the capabilities of electron microscopy in materials science, biology, integrated electronics, integrated optics, and other fields of research.

A variety of samples can be studied using the sample holder 140 and advanced microscopy. The samples studied can range from organic and inorganic materials to biological samples. Samples include, but are not limited to, materials used for integrated electronic and integrated optical devices, few-layer 2D materials such graphene and hexagonal boron nitride. Quantum aspects of some samples can be investigated, such as probing quantum-mechanical states in samples that exhibit quantum confinement (e.g., layered 2D materials, two-level systems in defects, and color centers in diamond which may be used to implement photonic qubits). For example, the inductor 224 can be used to investigate quantum sensing through optically-detected magnetic resonance (ODMR); the interdigitated electrodes 222 can localize excitons on layered 2D materials.

The sample holder 140 can be used for single-photon emission imaging applications to study optical emission from nano-scale or quantum emitters. The diffraction limit of conventional optical microscopes hinders their ability to visually distinguish optical emission from individual nano-scale emitters. Use of the sample holder 140 in conjunction with SEM imaging and photodetection (either integrated on the sample holder 140 or included in the SEM chamber) can provide highly accurate control over the localization of quantum emission from emitters and observation of the emitters during operation. In some implementations, current to stimulate emission can be provided from the focused electron beam used to image the emitter, though current and/or electric field could also be provided by a device formed on the sample holder 140 (e.g., electrodes 222).

Various electronic properties of materials can be studied, at atomic scale resolution and under different external stimuli, using the sample holder 140 and secondary electron e-beam-induced current (SEEBIC) generated by an electron microscope. Such electronic properties include electrical conductivity, connectivity, and work function.

The sample holder 140 can be used to obtain information about material structure, morphology, along with electric and/or magnetic properties under in-situ operating conditions for a sample 130. Samples 130 located on the sample holder 140 on or over the devices 220 can be subjected to heat, electric fields, magnetic fields, and/or electromagnetic fields that emulate operating conditions for the sample. In some cases, the sample holder 140 and its inductor 224 can be used to study long-range magnetic order of 2D magnetic materials, such as Fe₃GeTe₂. Information about magnetic characteristics of materials can be useful for designing structures of prototype devices comprising the magnetic material.

The sample holder 140 and an inductor 224 or antenna fabricated on the sample holder can be used to generate microwave signals for quantum information science (e.g., quantum sensing through ODMR). The on-chip microwave generator or a heater 226 can be controlled to heat specific areas of a sample 130. This localized heating allows for detailed analysis of thermal effects and material behavior under controlled temperature conditions. The localized heating can also solve issues related to ice build-up for cryogenic imaging where dual etching (e.g., by an ion beam) and imaging (with either an ion beam or electron beam) of a sample are performed.

Among the devices 220 included on a sample holder 140 can be electronic integrated circuits (ICs) and photonic integrated circuits (PICs) to facilitate on-chip generation and detection of optical signals. Such circuitry could allow for dual excitation and collection modalities, such as electrical excitation (with a focused electron beam) and optical detection with one or more integrated photodetectors or optical excitation and imaging with an electron beam. On-platform optical filters, such as gratings, could be formed on the sample holder 140 to filter optical signals generated or detected when inspecting a sample 130.

Among the devices 220 included on a sample holder 140 can be piezoelectric transducers arranged to apply strain to a sample 130 (e.g., to stretch or compress the sample). Mechanical strain can affect optical characteristics, electrical characteristics, and/or internal structure of the material. Induced changes can include phase transitions, optical second-harmonic generation capability, and direct-indirect bandgap electron transitions. A piezoelectric transducer can comprise a region of piezoelectric material disposed on the sample holder 140 (e.g., formed in the process stack 210) and located adjacent to a region of non-piezoelectric material or to another region of piezoelectric material, such as shown in FIG. 8. A sample can be dry transferred to or mounted on the sample holder 140 such that the sample straddles and bonds to the adjacent piezoelectric and non-piezoelectric (or piezoelectric) materials.

The sample holder 140 can integrate multiple different components (e.g., different electrodes 222, inductors 224, heaters 226) on a single platform, offering multifunctional sample-inspection conditions. Researchers can customize the design of the sample holder 140, using CMOS processes, to suit their specific needs (e.g., select different dimensions, devices, and configurations for a wide range of material studies).

The sample holder 140 has applications beyond electron-beam microscopy to other modes of advanced microscopy, such as atomic force microscopy (AFM) and STM mentioned above. The integration of multiple characterization methods on a single sample holder 140 can offer a comprehensive approach to analyzing materials and their behavior. Researchers in biology, chemistry, physics, materials science, electrical engineering, and optical engineering can use the sample holders 140 to observe and analyze dynamic processes in real time at the nanoscale. For example, the sample holder 140 can provide insights into biological systems, helping researchers better understand cellular processes and interactions with external stimuli.

### 4. Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

Unless stated otherwise, the terms “approximately” and “about” are used to mean within ±20% of a target (e.g., dimension or orientation) in some embodiments, within ±10% of a target in some embodiments, within ±5% of a target in some embodiments, and yet within ±2% of a target in some embodiments. The terms “approximately” and “about” can include the target. The term “essentially” is used to mean within ±3% of a target.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” shall have its ordinary meaning as used in the field of patent law.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A sample holder for micrometer-scale microscopy, the sample holder comprising:
a bulk substrate; and
a process stack disposed on the bulk substrate, the process stack comprising:
apertures devoid of material passing through the process stack to allow electrons or ions to pass through the apertures when using the sample holder for the micrometer-scale microscopy; and
at least one patterned feature forming an etch mask for etching the apertures through the process stack.

2. The sample holder of claim 1, further comprising:
a cavity formed in the bulk substrate to allow the electrons or the ions to pass through the cavity when using the sample holder for the micrometer-scale microscopy.

3. The sample holder of claim 1, wherein the sample holder has been formed using at least one complementary metal-oxide-semiconductor (CMOS) process.

4. The sample holder of claim 1, wherein the bulk substrate comprises a semiconductor material.

5. The sample holder of claim 1, wherein the at least one patterned feature comprises:
a first patterned feature formed from an etch-resist material disposed at a first layer of the process stack; and
a second patterned feature formed from the etch-resist material disposed at a second layer of the process stack, the process stack further comprising at least one insulating layer separating the first patterned feature from the second patterned feature.

6. The sample holder of claim 1, further comprising:
an inductor formed on or in the process stack over the at least one patterned feature.

7. The sample holder of claim 6, wherein the inductor comprises a spiral conductor patterned on the sample holder.

8. The sample holder of claim 6, wherein the inductor is arranged to generate a magnetic field or electromagnetic field that extends from a sample-supporting surface of the sample holder to impinge on a sample when the sample is mounted on the sample-supporting surface.

9. The sample holder of claim 1, further comprising:
electrodes formed on or in the process stack over the at least one patterned feature.

10. The sample holder of claim 9, wherein the electrodes are arranged to generate an electric or electromagnetic field that extends from a sample-supporting surface of the sample holder to impinge on a sample when the sample is mounted on the sample-supporting surface.

11. The sample holder of claim 10, wherein the electrodes comprise parallel conductive bars.

12. The sample holder of claim 11, wherein the parallel conductive bars are electrically connected to form interdigitated electrodes.

13. The sample holder of claim 10, wherein the electrodes comprise:
a first pointed conductor with a first apex to intensify an electric field formed by the electrodes; and
a second pointed conductor located a distance less than 5 microns from the first pointed conductor and having a second apex located adjacent to the first apex to intensify the electric field.

14. The sample holder of claim 10, wherein the electrodes comprise an array of conductive pillars connected by conductive traces.

15. The sample holder of claim 1, further comprising:
a heater formed on or in the process stack over the at least one patterned feature.

16. The sample holder of claim 15, wherein the heater comprises a spiral heating element formed on or in the process stack over the at least one patterned feature.

17. The sample holder of claim 1, further comprising:
a plurality of integrated devices formed on or in the process stack to apply at least one of heat, an electric field, a magnetic field, or an electromagnetic field to at least one sample when the at least one sample is mounted on the sample holder for the micrometer-scale microscopy; and
at least one contact pad disposed on or in the process stack to make electrical connection to at least one integrated device of the plurality of integrated devices.

18. The sample holder of claim 17 in combination with a printed circuit board (PCB), wherein:
the sample holder is mounted on the PCB; and
the at least one contact pad is electrically connected to a conductive trace on the PCB.

19. The sample holder of claim 1, further comprising:
a piezoelectric transducer formed on or in the process stack to strain a sample when the sample is mounted on the sample holder for the micrometer-scale microscopy.

20. The sample holder of claim 1, further comprising:
at least one integrated optical device formed on or in the process stack.

21. A method of inspecting a sample with the sample holder of claim 1, the method comprising:
receiving the sample on a device formed on or in the process stack over the at least one patterned feature; and
affecting a characteristic of the sample with an electric field, a magnetic field, or an electromagnetic field generated by the device.

22. The method of claim 21, wherein the device comprises electrodes disposed on or in the process stack, the electrodes generating an electric field or an electromagnetic field that impinges on the sample.

23. The method of claim 21, wherein the device comprises an inductor disposed on or in the process stack, the inductor generating a magnetic field or an electromagnetic field that impinges on the sample.
